(19) United States
(12) Patent Application Publication
(10) Pub. No.: US 2011/0302017 A1
(43) Pub. Date: Dec. 8, 2011

(54) Mobile Coupon Redemption System

(76) Inventors: Juan Marti, Danville, CA (US); Chad Roberts, Martinez, CA (US)

(21) Appl. No.: 12/959,825

(22) Filed: Dec. 3, 2010

Related U.S. Application Data
(60) Provisional application No. 61/267,073, filed on Dec. 6, 2009.

(51) Int. Cl. G06Q 30/00

(52) U.S. Cl. 705/14.26

(57) ABSTRACT

A mobile coupon redemption system enables a customer to receive a mobile coupon offer on his mobile phone, and to display the offer to a merchant. The customer is prompted to obtain a “merchant code” from the merchant, who obtains the merchant code from a local secure hardware token. The customer then communicates the merchant code by his mobile phone to a remote coupon application server, which validates to the merchant code, records the merchant and customer information, and validates the coupon for display to and redemption by the merchant.

This application claims benefit of provisional patent application 61/267073, filed Dec. 6, 2009.

### BACKGROUND OF THE INVENTION

The present invention is in the technical field of mobile coupon applications. More particularly, the invention provides a method and system for securely and cost effectively validating mobile coupons in real time.

Existing mobile coupons solutions provide specific codes that a merchant can manually enter or scan into their POS (point of sale) system, write down to be entered in later, or key into a device capable of collecting data. The device may be a personal computer, mobile device, laptop or other data collection device. The data collection device may be connected to the internet or not. In any event, after entering the coupon code via the data collection devices, the data are submitted to an application and validated.

The primary reason for entering the coupon code is so the merchant can validate and track sales in real-time or record and confirm at a later point. The current limitation of recording and validating mobile coupons with the methods described is that they are costly and in many cases are not practical, considering how a merchant does business. This is particularly a problem with small merchants who do not utilize costly and sophisticated POS systems or do not have easy access to computers.

Another important reason for entering a coupon code is to associate a coupon redemption with a particular customer. This added data point allows the merchant to capture customer information such as name, email, phone number and other data. The collection of this data is very valuable to the merchant as he or she can then target and track his customers.

Should a small merchant want to validate mobile coupons and associate redemptions with customers, without the expense of obtaining a POS system or upgrading an existing POS, they can instead employ a computer device such as a PDA, phone, PC, or laptop connected to the internet and validate the coupon codes by entering or scanning them. While this investment and additional step enable a merchant to validate mobile coupons in real-time, it is highly disruptive to the flow of business and adds additional costs.

A cost effective, simpler, and yet secure solution is needed to better enable merchants to validate mobile coupons and associate these redemptions with a customer purchase in real-time.

### SUMMARY OF THE INVENTION

The present invention is a mobile coupon redemption process that utilizes a customer's mobile device, a physical hardware security token located at the merchant's store, and a software system including one or more applications and database servers connected to the internet.

The present invention overcomes the shortcomings mentioned earlier, especially for small merchant locations that do not have POS equipment or those that do have POS systems but do not want to pay for the necessary software customizations and integrations.

This invention enables any merchant to securely validate mobile coupons and associate them with customers. The only hardware the merchant need have is an inexpensive hardware token which generates a unique, dynamically changing, merchant code number. This number, which changes every 30-60 seconds, must be communicated to a customer wanting to redeem a given coupon, in order for the coupon to be validated. The customer can then enter this unique code into their mobile phone, whereupon the code is verified in real time by a coupon validation server, which returns the status of the coupon and its corresponding value to the mobile phone.

One of the key components of the present solution is the utilization of physical hardware security tokens, or ID tags commonly used in banking industry. Instead of requiring the merchant to write down a coupon code, or go to another application to validate a mobile coupon, the merchant need only give their unique merchant code to the customer, and let the customer validate it via their mobile phone. An application server then compares the entered merchant code and the associated coupon offer ID over the phone. These values and other data points are then compared to a database and the correct token ID is found; then this information is sent to the token application server where the token ID entered by the customer is validated.

According to the invention, these security tokens, a customer's mobile phone, a software system and one or more application servers authenticate, validate, and associated purchases of mobile coupons to an actual customer in real-time, without requiring merchants to significantly alter their existing processes or purchase additional computer peripherals or connectivity.

Advantages of the present invention include that it is very cost effective, very secure, and simple to implement. The invention does not require any significant changes to a merchant's process of checking/ringing up his customers, nor are there any significant hardware costs to the solution.

In broad sense, the present invention is a software and hardware solution enabling the efficient, secure, and cost effective real-time validation and associated specific customer redemption of mobile coupons for any merchant.

### BRIEF DESCRIPTION OF THE DRAWINGS

FIG. 1 is a view of the overall system and the actors/users involved.

FIG. 2 is a flow of the method steps in the invention.

FIG. 3 is view of a sample coupon displayed on a mobile phone.

FIG. 4 illustrate the flow of data as a code is validated via a customer's mobile phone and the associated servers.

### DETAILED DESCRIPTION OF THE INVENTION

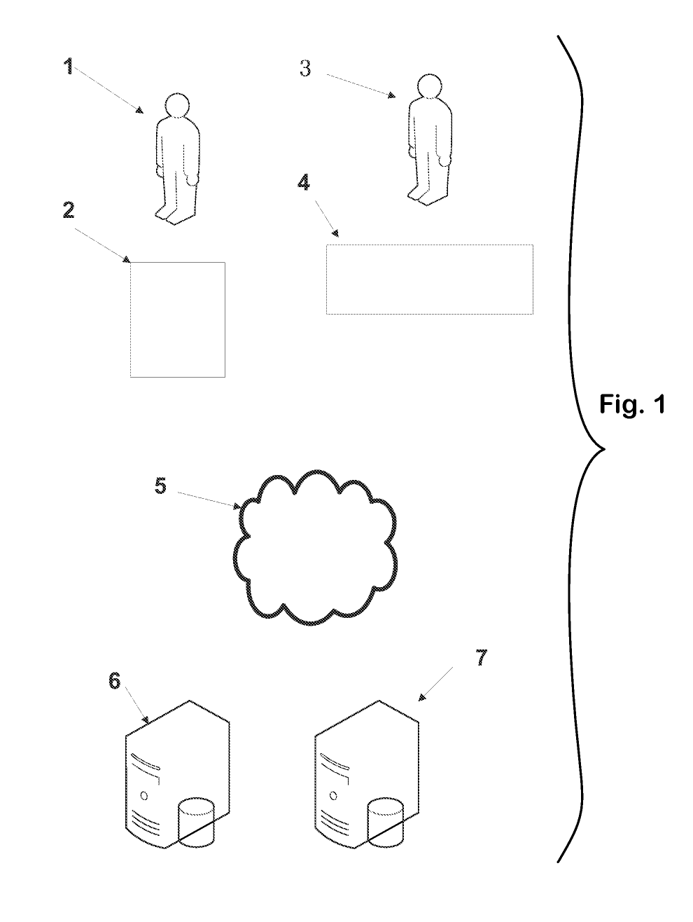

The basic elements of the invention are shown in FIG. 1. A customer 1 has a mobile phone 2, which displays a mobile coupon offer for the merchant 3 he is visiting. The merchant maintains a hardware token device 4 in his store. Reference 5 indicates a communications network, which may be the internet. Elements 6 and 7 are a Coupon Application Server and a Token Application Server, which are discussed below.

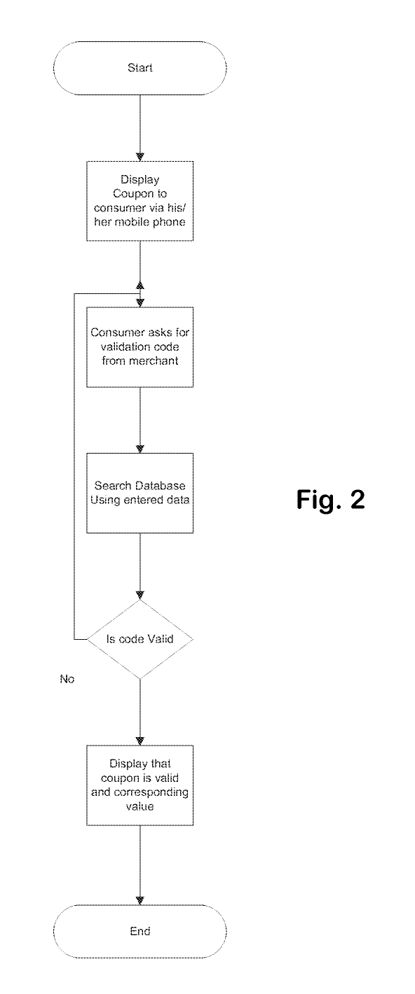

FIG. 2 illustrates the flow of the process.

First, using the mobile phone, the customer selects a coupon he or she wants to redeem at a particular store. The mobile application prompts the customer to request a “merchant code” from the merchant in order for the coupon to be accepted and validated. The merchant code is generated by a physically secure hardware token possessed by the merchant.

Once the customer has obtained the merchant code from the merchant, he or she enters it into the mobile phone and selects “submit.” This sends the merchant code and other associated data to a remote coupon application server. This request is received and looked up in the coupon application server's database to identify the corresponding offer and the customer's mobile coupon data.

Next, the Coupon Application Server passes the unique token ID along with the merchant's code to the Token Application Server, which validates the request. If the request is determined to be valid, this confirms that the customer is at the merchant location to redeem the mobile coupon.

Next, the Coupon Application Server determines the discount amount or coupon value and sends a message back to the customer which he can show to the merchant, whereupon the sales transaction can be completed. If the request is determined to be invalid, the customer can request a new code and try again.

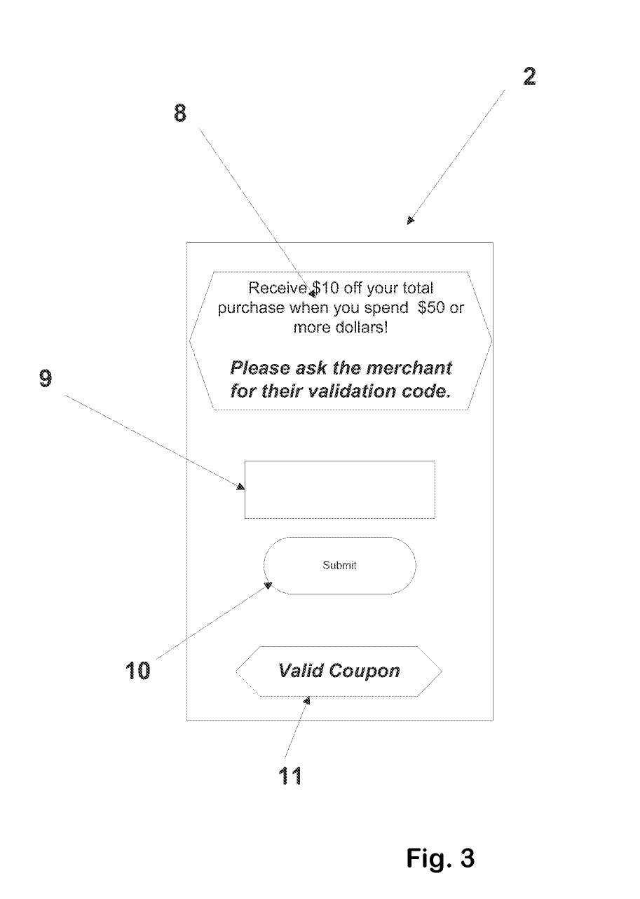

In FIG. 3, which represents the mobile phone display seen by the customer, the coupon offer 8 is shown displayed at the top of the phone 2.

The software application installed on the phone prompts the user to request a merchant code from the business owner or cashier.

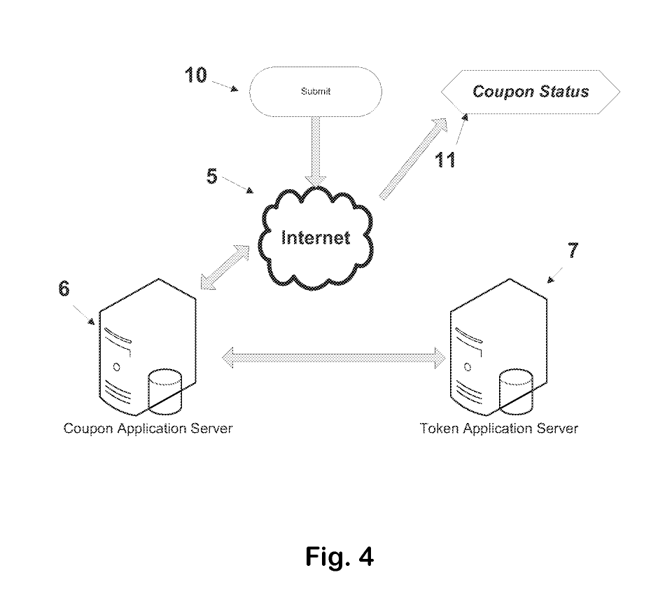

Having obtained the merchant code, the customer enters it into the mobile phone's text box field 9 (FIG. 3). The customer then presses the submit button 11 to transmit the merchant code, along with the coupon code and other associated data, to the Coupon Application Server 6 (see FIG. 4).

As shown in FIG. 4, the coupon application server and token application server communicate via a secure link.

While the foregoing written description of the invention enables one of ordinary skill to make and use what is considered presently to be the best mode of the invention, it should be understood the invention is subject to modifications and variations. For example, the functions described above as being performed by the coupon application server might be performed by other devices, for example, by an application installed on a mobile phone.

The foregoing description should therefore be regarded as merely illustrative of the invention defined by the claims below.

I claim:

1. A mobile coupon redemption system comprising
a customer-held mobile phone,
an application for displaying a coupon offer on the mobile phone,
a merchant-held secure hardware token for generating a merchant code, and
a coupon application server which generates the coupon offer, receives the merchant code, and validates the coupon offer.

2. The system of claim 1, further comprising a token application server, in communication with the coupon application server, for validating the merchant token.

3. A mobile coupon redemption system consisting of
a customer-held mobile phone,
a merchant-held secure hardware token for generating a merchant code,
a coupon application server for generating a coupon offer, sending the coupon offer to the mobile phone, receiving the merchant code from the mobile phone, validating the coupon offer and returning a coupon validation result to the mobile phone, and
a token application server, in communication with the coupon application server, for receiving the merchant code from the coupon application server, validating the merchant token, and returning a merchant code validation result to the coupon application server.

4. A method of redeeming mobile coupons, said method comprising steps of
generating a mobile coupon offer,
communicating the offer to a potential customer via mobile phone,
prompting the potential customer to obtain a merchant code from a merchant willing to redeem the coupon,
generating a merchant code with a secure hardware token,
communicating the merchant code to the potential customer,
communicating the merchant code to a coupon application server via the mobile phone,
validating the merchant code, and, if the merchant code is valid,
communicating a coupon validation to the potential customer for presentation by the potential customer to the merchant.
